(19) United States
(12) Patent Application Publication
(10) Pub. No.: US 2007/0162552 A1
(43) Pub. Date: Jul. 12, 2007

(54) Method and system for providing an instant messaging camp-on service

(75) Inventors: Shmuel Shaffer, Palo Alto, CA (US); Denise G. Caballero-McCann, Raleigh, NC (US); Labhesh Patel, San Francisco, CA (US); Mukul Jain, Santa Jose, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/328,713

(22) Filed: Jan. 10, 2006

(51) Int. Cl. G06F 15/16

(52) U.S. Cl. 709/207

(57) ABSTRACT

A method for providing an instant messaging camp-on service includes receiving, via a first instant messaging device, a request from a first user to log into an instant messaging server and to camp-on an instant messaging availability of a second user, wherein the second user is currently unavailable. The method also includes monitoring the instant messaging availability of the second user and determining that the second user is available via instant messaging and then notifying the first user via a first communication method of the instant messaging availability of the second user. The first communication method is different from instant messaging communication.

### TECHNICAL FIELD OF THE INVENTION

This invention relates in general to communication systems and, more particularly, to a method and system for providing an instant messaging camp-on service.

### BACKGROUND OF THE INVENTION

The field of communications has become increasingly important in today's society. In particular, the ability to quickly and effectively interact with an individual (through any suitable communications media) presents a significant obstacle for component manufacturers, system designers, and network operators. This obstacle is made even more difficult due to the plethora of diverse communication technologies (e.g. instant messaging, cellular communications, simple voice sessions, etc.) that exist in the current marketplace.

Instant messaging (IM) systems are gaining acceptance as a means for real time communication. Typically, a person may communicate in multiple instant messaging sessions at the same time. Some existing systems allow users to mark themselves as busy. Additionally, IM systems provide users attempting to initiate IM sessions with the ability to be notified when someone they want to communicate with logs into the IM system or is no longer busy and thus becomes available for an IM chat. A problem arises when the party attempting to initiate an IM session needs to leave his IM endpoint and thus cannot get the IM notification regarding the target user on his IM service.

Camp-on services are a common feature in most Private Branch Exchanges (PBXs). This feature allows a caller who calls an individual whose line is busy, to have her phone connected to the called party when the called party completes his call. When the called party hangs up, the system automatically connects the caller to the called party.

### SUMMARY OF THE INVENTION

The present invention provides a method and system for providing an instant messaging camp-on service that substantially eliminates or reduces disadvantages and problems associated with previous systems and methods.

In accordance with a particular embodiment of the present invention, a method for providing an instant messaging camp-on service includes receiving, via a first instant messaging device, a request from a first user to log into an instant messaging server. The method includes receiving a request from the first user to camp-on an instant messaging availability of a second user who is currently unavailable. The method includes monitoring the instant messaging availability of the second user and determining that the second user is available via instant messaging and notifying the first user via a first communication method of the instant messaging availability of the second user. The first communication method is different from instant messaging communication.

The method may also include determining that the second user is currently unavailable and then notifying the first user that the second user is currently unavailable. The method may also include providing the first user with a graphical user interface through which the first user may request to camp-on an instant messaging availability of the second user.

Where the method includes notifying the first user via a first communication method of the instant messaging availability of the second user the method may also include notifying the first user of the instant messaging availability of the second user at a device different from the first instant messaging device. The first communication method may also include phone communication, e-mail communication or SMS communication.

Where the method includes notifying the first user via a first communication method of the instant messaging availability of the second user the method may also include establishing a cross media exchange between the first user and the second user. Establishing a cross media exchange between the first user and the second user may include utilizing text-to-speech (TTS) technology to communicate instant messaging communications of the second user to the first user. It may also include utilizing adaptive speech recognition (ASR) or natural speech recognition technology to communicate first communication method communications of the first user to the second user.

Where the method includes receiving a request from the first user to camp-on the instant messaging availability of the second user the method may also include receiving, via the first communication method, the request to camp-on the instant messaging availability of the second user.

In accordance with another embodiment of the present invention, a system for providing an instant messaging camp-on service includes an interface operable to receive, via a first instant messaging device, a request from a first user to log into an instant messaging server. The interface is further operable to receive a request from the first user to camp-on an instant messaging availability of a second user who is currently unavailable. The processor is further operable to monitor the instant messaging availability of the second user and to determine that the second user is available via instant messaging. The processor is further operable to notify the first user via a first communication method of the instant messaging availability of the second user, the first communication method is different from instant messaging communication.

Technical advantages of particular embodiments include enabling a first user to receive a notification that a previously unavailable second user is now currently available, even if the first user has stepped away from the device that he used to log into the IM server. Accordingly, the user may increase his productivity by not having to waste time at a single endpoint waiting for another user to become available through IM. Some embodiments allow for an alternate communication session to be created between the first user and the second user where the alternate communication session is between different types of devices using different types of media. Accordingly, the first user can, for example, use his cell phone to verbally participate in a communication session with the second user who may be using text messages on his computer.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system including a plurality of endpoints operable to communicate among each other and a plurality of instant messaging servers, in accordance with a particular embodiment of the present invention;

FIG. 2 illustrates an instant messaging server of FIG. 1 in more detail, illustrating aspects of the present invention; and

FIG. 3 illustrates a method for providing an instant messaging camp-on service, in accordance with an embodiment of the present invention.

### DETAILED DESCRIPTION OF THE INVENTION

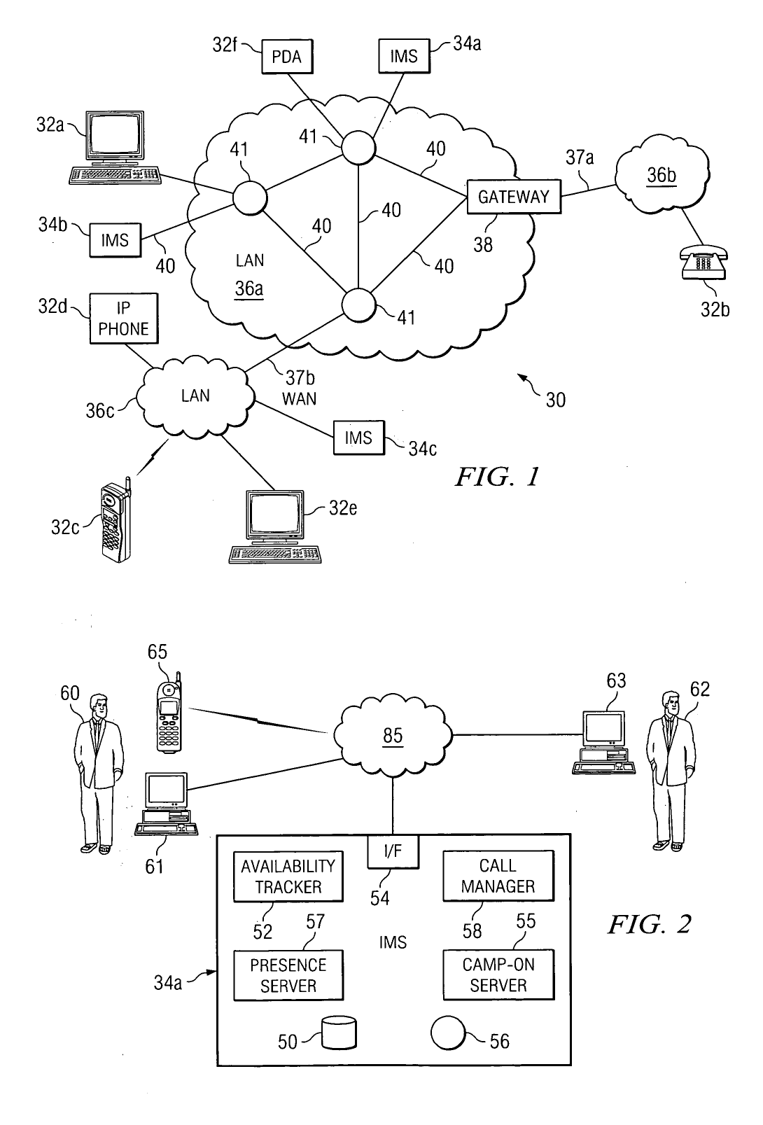

FIG. 1 illustrates a communication system 30 including a plurality of endpoints 32a-32f having the ability to communicate with each other and/or IM servers (IMSs) 34a-34c. At least some of endpoints 32a-32f have the ability to establish an IM communication session with other users, using one or more of communication networks 36a-36c. IMSs 34a-34c facilitate IM communications, such as the communication of text messages in almost real time, between endpoints 32a-32f. IM allows users to form lists of people with whom they wish to communicate, such as a “buddy list.” Typically, users may communicate with anyone on their buddy list who is presently on-line and available. IM servers 34a-34c provide numerous different services such as the registration, authentication and tracking of IM users, the processing of messages, such as text messages between endpoints 32a-32f, and providing the status of other users, such as those on a user's buddy list.

In particular embodiments, IMSs 34a-34c integrate multiple different communication methods into a single powerful system that provides multi-modality notification functionality as well as cross media communication exchanges as part of a camp-on service. By integrating voice services and IM services it is possible to set up a communication session that seamlessly sends communications between users who are using different services. IMSs 34a-34c provide an IM camp-on service for a user who desires to be alerted of a change in another user's availability status through a different program or on a different device from the one he used to initiate the camp-on service. Similarly, in some embodiments, IMSs 34a-34c provide an IM camp-on service for a user who desires to create a cross media communication session with the other user once the other user becomes available. By providing the camp-on functionality at the server level the user can invoke the camp-on service and have it running even if the user logs out of her current IM session and shuts downs down the device that she used to initiate the IM session. In some cases this functionality may be provided through an IM client running on an endpoint, for example endpoint 32a. Providing the camp-on functionality at the endpoint level allows a single user to add the camp-on functionality to his own IM client program and then use it to camp-on the IM availability of other users regardless of whether or not they have any camp-on functionality installed into their own IM client.

In the illustrated embodiment, communication network 36a is a local area network (LAN) that enables users to communicate messages between a plurality of endpoints 32a-32f and IMSs 34a-34c distributed across multiple cities and geographic regions. Communication network 36a also provides a means for endpoints 32a-32f and IMSs 34a-34c to communicate control and status signals. Communication network 36b is a public switched telephone network (PSTN) and couples endpoint 32b with communication network 36a through gateway 38. Communication network 36c is another LAN, which couples endpoints 32c, 32d and 32e and IMS 34c with communication network 36a. Accordingly, not only can users of endpoints 32a-32f establish communication sessions between and among each other but endpoints 32a-32f, IMSs 34a-34c and any other network components coupled to one or more of networks 36a-36c can communicate status and control signals between and among each other. Communication links 37a and 37b couple communication networks 36a and 36b, and communication networks 36a and 36c, respectively. In the illustrated embodiment, communication link 37b is a wide area network (WAN), which couples LANs 36a and 36c.

Communication network 36a includes a plurality of segments 40 and nodes 41 that couple endpoints 32a and 32f with IMSs 34a and 34b, gateway 38 and communication networks 36b-36c. Therefore, a user of endpoint 32a is provided with access to endpoints 32b-32f, and IMSs 34a-34c. Nodes 41 may include any combination of network components, gatekeepers, call managers, conference bridges, routers, hubs, switches, gateways, endpoints, or other hardware, software, or embedded logic implementing any number of communication protocols that allow for the exchange of packets in communication system 30.

Although the illustrated embodiment includes three communication networks 36a-36c, the term “communication network” should be interpreted as generally defining any network capable of transmitting audio and/or video telecommunication signals, data, and/or messages, including signals, data or messages transmitted through text chat, instant messaging and e-mail. Any one of networks 36a-36c may be implemented as a local area network (LAN), wide area network (WAN), global distributed network such as the Internet, Intranet, Extranet, or any other form of wireless or wireline communication network. Generally, network 36a provides for the communication of packets, cells, frames, or other portions of information (generally referred to as packets herein) between endpoints 32a-32f. Communication network 36a may include any number and/or combination of segments 40, nodes 41, endpoints 32a-32f, and/or IMSs 34a-34c.

In a particular embodiment, communication network 36a employs communication protocols that allow for the addressing or identification of endpoints, nodes, and/or IMSs coupled to communication network 36a. For example, using Internet Protocol (IP), each of the components coupled together by communication network 36a in communication system 30 may be identified using IP addresses. In this manner, network 36a may support any form and/or combination of point-to-point, multicast, unicast, or other techniques for exchanging media packets among components in communication system 30. Any network components capable of exchanging IM, audio, video, or other data using frames or packets, are included within the scope of the present invention.

Network 36a may be directly coupled to other IP networks including, but not limited to, another LAN or the Internet. Since IP networks share a common method of transmitting data, telecommunication signals may be transmitted between telephony devices located on different, but interconnected, IP networks. In addition to being coupled to other IP networks, communication network 36a may also be coupled to non-IP telecommunication networks through the use of interfaces or components, for example gateway 38. In the illustrated embodiment, communication network 36a is coupled with PSTN 36b through gateway 38. PSTN 36b includes switching stations, central offices, mobile telephone switching offices, pager switching offices, remote terminals, and other related telecommunications equipment that are located throughout the world. IP networks transmit data (including IM, voice and video data) by placing the data in packets and sending each packet individually to the selected destination, along one or more communication paths. Unlike a circuit-switched network (like PSTN 36b), a dedicated circuit is not required for the duration of a call or fax transmission over IP networks.

In particular embodiments, communication system 30 may receive and transmit data in a session initiation protocol (SIP) environment. SIP is an application-layer control protocol that includes primitives for establishing, modifying and terminating communication sessions. SIP works independently of underlying transport protocols and without dependency on the type of session that is being established. SIP also transparently supports name mapping and redirection services, which support personal mobility.

It will be recognized by those of ordinary skill in the art that endpoints 32a-32f, IMSs 34a-34c and/or gateway 38 may be any combination of hardware, software, and/or encoded logic that provides communication services to a user. For example, endpoints 32a-32f may include a telephone, a personal computer (PC), a video monitor, an IP phone, a cell phone, a personal digital assistant (PDA) or any other communication hardware, software and/or encoded logic that supports the communication of packets of media (or frames) using communication network 36a. Endpoints 32a-32f may also include unattended or automated systems, gateways, other intermediate components or other devices that can establish media sessions. Although FIG. 1 illustrates a particular number and configuration of endpoints, IMSs, segments, nodes, and gateways, communication system 30 contemplates any number or arrangement of such components for IM communications.

FIG. 2 illustrates IMS 34a in more detail, in accordance with a particular embodiment of the present invention. In the illustrated embodiment, IMS 34a includes a memory module 50, availability tracker 52, interface 54, camp-on server 55, processor 56, presence server 57, and call manager 58. Interface 54 connects IMS 34a to communication network 85. Processor 56 may be a microprocessor, controller, or any other suitable computing device, resource, or combination of hardware, software and/or encoded logic. Processor 56 may work in conjunction with other components of IMS 34a, such as camp-on server 55, to provide the functionality of IMS 34a discussed herein. The functionality discussed herein may also be provided through an endpoint, such as endpoint 61, that is connected to IMS 34a.

Memory module 50 may be any form of volatile or non-volatile memory including, without limitation, magnetic media, optical media, random access memory (RAM), read-only memory (ROM), removable media, or any other suitable local or remote memory component. Memory module 50 may store any suitable information necessary to accomplish the IMS functionality described herein, such as alternate notification methods for particular users and operational instructions associated with users, as further discussed below.

Camp-on server 55 provides IM camp-on functionality to users of IMS 34a as discussed herein. Camp-on server 55 may comprise any suitable processor, computing device, resource or combination of hardware, software or encoded logic and may provide its functionality through processor 56. Some embodiments may utilize a camp-on server that is remotely coupled to an IMS through one or more communication networks.

Availability tracker 52 monitors or otherwise keeps track of the IM availability of users, such as users 60 and 62. Availability tracker 52 may also be used to keep track of current communication sessions, whether IM, phone or otherwise, in which various users are participating. Availability tracker 52 may be any combination of hardware, software and/or encoded logic. In some cases, availability tracker 52 may work with camp-on server 55, call manager 58, presence server 57 or other components to keep track of current communication sessions of users.

A call manager may be used to maintain information on users of a communication system, for example communication system 30 depicted in FIG. 1, and may facilitate communication among users. In particular embodiments call manager 58 may be integrated within IMS 34a and may retrieve and/or maintain a listing, table, or other organization of information about users. Some embodiments may include a call manager remotely connected to an IMS via a network, such as an IP network, to provide similar functionality. The information maintained by call manager 58 may include a name or other identifier for a user and contact information such as phone numbers and email addresses for the user. Call manager 58 may provide its functionality through processor 56 and memory 50 of IMS 34a.

A presence server may be used to detect and monitor the presence of users communicating within a communication system, such as communication system 30 depicted in FIG. 1. In particular embodiments presence server 57 may be integrated within IMS 34a and may detect information about users 60 and 62. This information may be used to route notifications to a camping user based on their location as detected by presence server 57. Some embodiment may include a presence server remotely connected to an IMS via a network, such as an IP network. Presence server 57 may provide its functionality through processor 56 and memory 50 of IMS 34a. Additionally, presence server 57 may include a single computer or a group of computers that are capable of detecting the presence and current communication session of a user at an endpoint associated with the user. Examples of presence servers include presence servers as defined by IETF specifications.

While FIG. 2 depicts computer endpoints 61 and 63 and cell phone endpoint 65, IMS 34a may be used with any appropriate number of suitable endpoints, such as those described above with respect to FIG. 1. In the illustrated embodiment, endpoints 61, 63 and 65 are coupled to each other and to IMS 34a through communication network 85, which may comprise one or more communication networks such as the communication networks described above with respect to FIG. 1.

As an example in operation, user 60 utilizes endpoint 61 to attempt to establish an IM communication session with user 62 who is presently unavailable. To establish the IM communication session user 60 runs an IM client program (e.g. ICQ) from endpoint 61 which, in this example, is a computer. The IM client communicates with IMS 34a through interface 54 to log user 60 into IMS 34a. At least part of the login process may involve authenticating user 60 to IMS 34a. Once the IM client has properly logged user 60 into IMS 34a user 60 can attempt to establish an IM communication session with any other user who is presently logged in and available for IM communication (for purposes of this example all users know the necessary IM contact information of all the other users). User 60 may be informed of the availability of the other users through a graphical user interface that may be part of the IM client. The other users' availability status may be received from IMS 34a by utilizing the services of availability tracker 52. Availability tracker 52 detects that user 60 has begun an IM session and then, in combination with processor 56 and memory 50, communicates to user 60 the availability status of the other users.

Here, user 62 is presently unavailable for IM communication. He may be unavailable for any of a number of reasons. For example, he may not have logged into IMS 34a, or he may be logged into IMS 34a but he may have elected to indicate his status as unavailable, or may have timed-out, causing his IM client or IMS 34a to mark his status as unavailable even though he is still logged in. By taking advantage of some of the various features that may be present in the functionality contained within IMS 34a or the IM client program running on endpoint 61, user 60 is able to camp-on to the IM availability of user 62.

There is a wide variety of ways in which a user can submit a camp-on request. For example, in some embodiments the user can submit his request using a “right-click” pop-up menu. In this embodiment, when user 60 logs into IMS 34a his IM client will show that user 62 is presently unavailable for IM communication. User 60 can then “right-click” on the user 62's IM identification to cause a pop-up menu to appear. One of the options on the menu would be to camp-on the IM availability of the presently unavailable second user. In some embodiments this would be all that user 60 would need to do to invoke the camp-on service. In some embodiments, after electing to invoke a camp-on service user 60 would be prompted with a request for the type, location and/or device that he wants to use to receive his notification or conduct his cross media communication session.

Whether or not user 60 has to input information regarding how he wants to be notified will depend on how IMS 34a is configured. For example, user 60 could input the necessary information the first time he logs into IMS 34a, and then IMS 34a may store that information in memory 50. Another possible scenario in which user 60 might not need to enter information concerning how he is notified is if IMS 34a uses presence server 57 to determine where to send the notification. As mentioned above, the camp-on request, and accompanying notification information, can be stored and processed by an IM client.

Once a camp-on request has been received, the actual camp-on service is invoked. Here, this entails IMS 34a using some combination of camp-on server 55, availability tracker 52, processor 56 and memory 50 to monitor the IM availability of user 62. For example, camp-on server 55 could maintain the camp-on services requested by users connected to IMS 34a. In doing so it may rely on availability information generated by availability tracker 52 to determine who is and is not available. Camp-on server 55 may also use processor 56 to execute any logic camp-on server 55 needs to function including processing information from availability tracker 52. Camp-on server 55 may further utilize memory 50 to store the camp-on requests.

In some embodiments of the present invention, by invoking an IM camp-on service, user 60 can choose to have notifications of user 62's IM availability status sent via methods and/or devices other than those user 60 initially used to log into IMS 34a. For example, user 60 may choose to receive an e-mail, phone call or text message on cell phone 65 or a phone call on his office or home telephone. In this case, IMS 34a may use a combination of call manager 58, processor 56 and memory 50, to attempt to initiate the phone call with his office or home telephone.

Similarly, in some embodiments user 60 can choose to have a cross media communication session created when user 62 becomes available. In a cross media communication session user 60 is not only notified that user 62 is available, but user 60 is also able to establish a communication session with user 62. The communication session in a cross media communication session involves sending and receiving communications using different methods. For example, user 60 may be talking/listening through his telephone to user 62 who is reading/typing on his computer, thus user 60 is using phone communications to communicate with user 62 who is using text communications. One possible scenario in which this can be advantageous occurs when user 60 needs to leave endpoint 61, which he used to invoke the camp-on service, but he still wants to be able to communicate with user 62 once user 62 becomes available for IM communication. To do so, user 60 may elect to camp-on to user 62's availability status and to have the system attempt to initiate a communication session through cell phone 65 once user 62 becomes available. In this scenario, when user 62 becomes available, IMS 34a establishes a cross media communication session between user 62, utilizing IM on endpoint 63, which is a computer, and user 60 using phone communications on cell phone 65. In order for user 60 to be able to communicate to user 62 in this manner, IMS 34a utilizes a combination of processor 56 and memory 50 to enable ASR or natural speech recognition technology. Processor 50 may execute a program stored in memory 50 that converts the spoken words of user 60 into textual messages that can be displayed on the computer monitor of user 62. Additionally, some combination of processor 56 and memory 50 may be used to enable TTS technology. Processor 56 may execute a program stored in memory 50 to convert the typed communications of user 62 into audible messages for user 60 to hear through the speaker of cell phone 65. While in this example user 62 sent and received his messages from computer 63, the same functionality can be employed if user 62 was using a PDA or other similar device to run his IM client. In this manner IMS 34a enables users to communicate to one another through a cross media communication session even though both users are not presently able to access their respective IM endpoints. It should be noted that the text-to-speech and speech recognition technology can also be provided by other servers that are connected to IMS 34a, through for example network 85, using standard protocols like the Internet Engineering Task Force's Media Resource Control Protocol.

It will be recognized by those of ordinary skill in the art that IMS 34a is merely one example configuration of an IMS for using an instant messaging camp-on service in accordance with particular embodiments. IMS 34a may include any number of camp-on servers, interfaces, processors, memory modules and availability trackers to accomplish the functionality and features described herein. For example, although IMS 34a is illustrated and described as including memory module 50, availability tracker 52, interface 54, camp-on server 55, processor 56, presence server 57 and call manager 58 these components and other desired components for performing the above described functionality may be centrally located (local) with respect to one another, or distributed throughout communication system 30. In addition, one or more components of IMS 34a may work together in performing various functionality described herein. Moreover, IMS 34a may work with other network components, such as a call manager or a presence server, to perform the various functionality described herein.

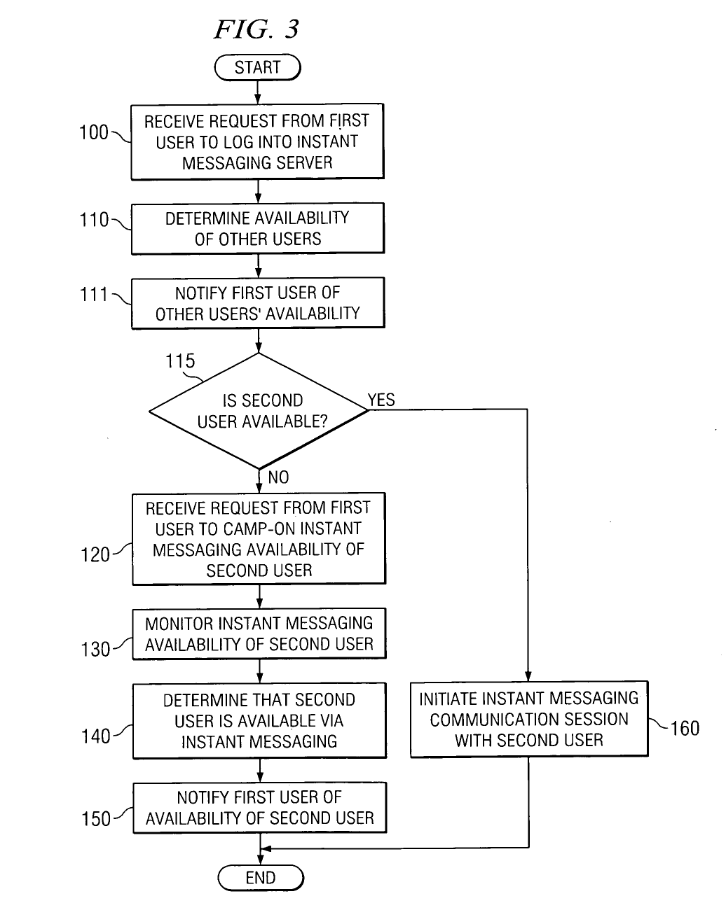

FIG. 3 is a flowchart illustrating a method for providing an instant messaging camp-on service in accordance with a particular embodiment. The method begins at step 100 where a request from a first user to log into an instant messaging server is received via a first instant messaging device. The first user may use his personal computer, PDA or any other appropriate endpoint to run his IM client program, such as ICQ, and from his IM client he is able to log into the IMS by authenticating himself to the IMS. Once the first user is logged into the IM server he is able to establish an IM communication session with any other presently available user thereby allowing the users to send and receive IM messages between each other.

When the first user logs into the IM server, the system authenticates him and, at step 110, determines the availability of all the other users on the first user's “buddy list.” The buddy list is a list of all the other users that the first user may want to communicate with and whose address he has provided through the IM client. The first user is then notified, at step 111, of the availability of the other users. This information may be relayed to the user in a variety of ways, for example the IM client could utilize a graphical user interface having a window that, for every user on his buddy list, displays a unique identifier for the user and an icon showing the IM availability of the user. This allows the first user to quickly and easily determine with whom he may have an IM communication session.

If, at step 115, the second user is available the first user, at step 160, can initiate an IM communication session with the second user. In doing so the IM client typically creates a separate window on the IM device that displays all the messages sent between the first user and the second user. If, on the other hand, at step 115, the second user is not available to participate in an instant messaging session with the first user and if the first user wishes, he can elect to submit a request to camp-on the instant messaging availability of the second user. This request is received at step 120. The second user's IM availability status could be determined to be unavailable for a variety of reasons. For example, the second user may not be logged into his IM session, or he may have logged into his IM session but may have been inactive for a length of time causing the IM client to mark him as unavailable. As another example, the user may have logged in and marked himself as unavailable. The reason why the second user is unavailable is not important for this step, it is only important that the first user is currently unable to communicate through IM with the second user because the second user is unavailable.

After receiving the request from the first user to camp on to the instant messaging availability of the second user the system containing the camp-on functionality (whether a server or an endpoint) monitors the IM availability of the second user at step 130. At step 140 it is determined that the second user is available. This determination may be made, for example, by an availability tracker which keeps track of the status of the users logged into the IM server. At step 150, the first user is notified via a first communication method that is different from instant messaging of the availability of the second user. The first communication method may comprise, for example, phone, e-mail or SMS communication. The notification can be sent via the first communication method to the same endpoint used by the first user to attempt the IM session, or it can be sent to a separate and/or different endpoint. For example, assume the first user used his computer to initially log into the IM server. The notification may comprise, for example, a phone call to the computer or to a cell phone of the first user.

In some embodiments of the present invention, in addition to alerting the first user that the second user is available, a communication session may be established between the first user and the second user in which the two users are able to communicate with one another regardless of the type of communication device they are using. For example, IM text entered by the second user may be converted using TTS technology so that the first user can hear on his cell phone what the second user has typed, and similarly, the messages that the first user speaks can be converted using ASR or natural speech recognition technology so that the second user can read what the first user said.

Some of the steps illustrated in FIG. 3 may be combined, modified or deleted where appropriate, and additional steps may also be added to the flowchart. Additionally, steps may be performed in any suitable order without departing from the scope of the invention.

As indicated above, technical advantages of particular embodiments include the ability to camp-on the IM availability of a user who is not presently available. Thus, particular embodiments allow a user, who is camping-on the IM availability of another user, to leave the endpoint from which he initiated the camp-on service without having to worry about missing the moment when the other user becomes available.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within communication system 30 and IMS 34a, these elements may be combined, rearranged or positioned in order to accommodate particular routing architectures or needs. In addition, any of these elements may be provided as separate external components to communication system 30, IMS 34a or each other where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for providing an instant messaging camp-on service, comprising:
receiving, via a first instant messaging device, a request from a first user to log into an instant messaging server;
receiving a request from the first user to camp-on an instant messaging availability of a second user, wherein the second user is currently unavailable;
monitoring the instant messaging availability of the second user;
determining that the second user is available via instant messaging; and
notifying the first user via a first communication method of the instant messaging availability of the second user, the first communication method different from instant messaging communication.

2. The method of claim 1, further comprising:
determining that the second user is currently unavailable; and
notifying the first user that the second user is currently unavailable.

3. The method of claim 2, further comprising providing to the first user a graphical user interface through which the first user may request to camp-on an instant messaging availability of the second user.

4. The method of claim 1, wherein notifying the first user via a first communication method of the instant messaging availability of the second user comprises notifying the first user of the instant messaging availability of the second user at a device different from the first instant messaging device.

5. The method of claim 1, wherein the first communication method comprises phone communication.

6. The method of claim 1, wherein the first communication method comprises e-mail communication.

7. The method of claim 1, wherein the first communication method comprises SMS communication.

8. The method of claim 1, wherein notifying the first user via a first communication method of the instant messaging availability of the second user comprises establishing a cross media exchange between the first user and the second user.

9. The method of claim 8, wherein establishing a cross media exchange between the first user and the second user comprises utilizing text-to-speech (TTS) technology to communicate instant messaging communications of the second user to the first user.

10. The method of claim 8, wherein establishing a cross media exchange between the first user and the second user comprises utilizing speech recognition technology to communicate first communication method communications of the first user to the second user.

11. The method of claim 1, wherein receiving a request from the first user to camp-on the instant messaging availability of the second user comprises receiving, via the first communication method, the request to camp-on the instant messaging availability of the second user.

12. A system for providing an instant messaging camp-on service, comprising:
an interface operable to:
receive, via a first instant messaging device, a request from a first user to log into an instant messaging server;
receive a request from the first user to camp-on an instant messaging availability of a second user, wherein the second user is currently unavailable;
a processor operable to:
monitor the instant messaging availability of the second user;
determine that the second user is available via instant messaging; and
notify the first user via a first communication method of the instant messaging availability of the second user, the first communication method different from instant messaging communication.

13. The system of claim 12, wherein the processor is further operable to:
determine that the second user is currently unavailable; and
notify the first user that the second user is currently unavailable.

14. The system of claim 13, wherein the processor is further operable to provide to the first user a graphical user interface through which the first user may request to camp-on an instant messaging availability of the second user.

15. The system of claim 12, wherein the processor operable to notify the first user via a first communication method of the instant messaging availability of the second user comprises a processor operable to notify the first user of the instant messaging availability of the second user at a device different from the first instant messaging device.

16. The system of claim 12, wherein the first communication method comprises phone communication.

17. The system of claim 12, wherein the first communication method comprises e-mail communication.

18. The system of claim 12, wherein the first communication method comprises SMS communication.

19. The system of claim 12, wherein the processor operable to notify the first user via a first communication method of the instant messaging availability of the second user comprises a processor operable to establish a cross media exchange between the first user and the second user.

20. The system of claim 19, wherein the processor operable to establish a cross media exchange between the first user and the second user comprises a processor operable to utilize text-to-speech (TTS) technology to communicate instant messaging communications of the second user to the first user.

21. The system of claim 19, wherein the processor operable to establish a cross media exchange between the first user and the second user comprises a processor operable to utilize speech recognition technology to communicate first communication method communications of the first user to the second user.

22. The system of claim 12, wherein the interface operable to receive a request from the first user to camp-on the instant messaging availability of the second user comprises an interface operable to receive, via the first communication method, the request to camp-on the instant messaging availability of the second user.

23. Logic embodied in a computer readable medium, the computer readable medium comprising code operable to:
receive, via a first instant messaging device, a request from a first user to log into an instant messaging server;
receive a request from the first user to camp-on an instant messaging availability of a second user, wherein the second user is currently unavailable;
monitor the instant messaging availability of the second user;
determine that the second user is available via instant messaging; and
notify the first user via a first communication method of the instant messaging availability of the second user, the first communication method different from instant messaging communication.

24. The medium of claim 23, wherein the code is further operable to:
determine that the second user is currently unavailable; and
notify the first user that the second user is currently unavailable.

25. The medium of claim 24, wherein the code is further operable to provide to the first user a graphical user interface through which the first user may request to camp-on an instant messaging availability of the second user.

26. The medium of claim 23, wherein the code operable to notify the first user via a first communication method of the instant messaging availability of the second user comprises code operable to notify the first user of the instant messaging availability of the second user at a device different from the first instant messaging device.

27. The medium of claim 23, wherein the first communication method comprises phone communication.

28. The medium of claim 23, wherein the first communication method comprises e-mail communication.

29. The medium of claim 23, wherein the first communication method comprises SMS communication.

30. The medium of claim 23, wherein the code operable to notify the first user via a first communication method of the instant messaging availability of the second user comprises code operable to establish a cross media exchange between the first user and the second user.

31. The medium of claim 30, wherein the code operable to establish a cross media exchange between the first user and the second user comprises code operable to utilize text-to-speech (TTS) technology to communicate instant messaging communications of the second user to the first user.

32. The medium of claim 30, wherein the code operable to establish a cross media exchange between the first user and the second user comprises code operable to utilize speech recognition technology to communicate first communication method communications of the first user to the second user.

33. The medium of claim 23, wherein the code operable to receive a request from the first user to camp-on the instant messaging availability of the second user is further operable to receive, via the first communication method, the request to camp-on the instant messaging availability of the second user.

34. A system for providing an instant messaging camp-on service, comprising:
means for receiving, via a first instant messaging device, a request from a first user to log into an instant messaging server;
means for receiving a request from the first user to camp-on an instant messaging availability of a second user, wherein the second user is currently unavailable;
means for monitoring the instant messaging availability of the second user;
means for determining that the second user is available via instant messaging; and
means for notifying the first user via a first communication method of the instant messaging availability of the second user, the first communication method different from instant messaging communication.
